(19) United States
(12) Patent Application Publication
(10) Pub. No.: US 2025/0028463 A1
(43) Pub. Date: Jan. 23, 2025

(54) STORAGE SYSTEM AND MANAGEMENT METHOD FOR STORAGE SYSTEM

(71) Applicant: Hitachi, Ltd., Tokyo (JP)

(72) Inventors: Tetsuaki NUKATA, Tokyo (JP); Shintaro ITO, Tokyo (JP); Takahiro YAMAMOTO, Tokyo (JP); Yoshinori OHIRA, Tokyo (JP)

(73) Assignee: Hitachi, Ltd., Tokyo (JP)

(21) Appl. No.: 18/443,873

(22) Filed: Feb. 16, 2024

(30) Foreign Application Priority Data
Jul. 19, 2023 (JP) 2023-117331

(51) Int. Cl. G06F 3/06

(52) U.S. Cl. CPC G06F 3/0631; G06F 3/0619; G06F 3/067

(57) ABSTRACT

A storage system includes: a plurality of storage nodes each including a processor; and a storage apparatus, in which the processor includes a plurality of processor cores and executes a plurality of programs for processing data input/output to/from the storage apparatus by using the processor cores, provides a volume that is a logical storage area, and adjusts the number of processor cores to be allocated to each of the plurality of programs.

### BACKGROUND OF THE INVENTION

### 1. Field of the Invention

The present invention relates to a storage system and a management method for a storage system.

### 2. Description of the Related Art

Conventionally, there is a technique described in JP 2021 026659 A in order to improve performance by appropriately allocating resources of a storage system. In this publication, there is a description of “Each of a plurality of nodes constituting a node group includes a hardware control unit including one or more drivers of a resource group of the node, and a command control unit that controls the hardware control unit in processing for input/output (I/O) according to an I/O command when the node receives the I/O command. At least one node includes an allocation determining unit. The allocation determining unit determines resource allocation to the hardware control unit and the command control unit for one or more nodes including the node on the basis of I/O characteristics of the one or more nodes. In each of the one or more storage nodes, of a resource amount of a resource group of the storage node, a resource amount allocated to each of the hardware control unit and the command control unit follows the determined resource allocation.”.

### SUMMARY OF THE INVENTION

In the above technique, CPU core allocation is determined in consideration of a write/read (RW) ratio with respect to a volume for storing data in a non-compressed manner. However, a difference in load due to a function or an attribute of a volume, such as a volume that can store data by compressing the data, is not considered. In addition, a difference in load due to an operating state of the storage node, such as a change in load due to failover, is not taken into consideration.

Therefore, an object of the present invention is to improve performance of a storage system by further appropriately allocating resources of the storage system in consideration of a difference in load depending on an attribute of a volume and/or an operating state of a storage node.

In order to achieve the above object, one of the representative storage systems of the present invention is a storage system including: a plurality of storage nodes each including a processor; and a storage apparatus, in which the processor includes a plurality of processor cores and executes a plurality of programs for processing data input/output to/from the storage apparatus by using the processor cores, provides a volume that is a logical storage area, and adjusts the number of processor cores to be allocated to each of the plurality of programs.

Further, one of representative management methods for a storage system of the present invention is a management method for a storage system, the storage system including: a plurality of storage nodes each including a processor; and a storage apparatus, in which the processor includes a plurality of processor cores and executes a plurality of programs for processing data input/output to/from the storage apparatus by using the processor cores, provides a volume that is a logical storage area, and adjusts the number of processor cores to be allocated to each of the plurality of programs.

According to the present invention, it is possible to improve the performance of the storage system by appropriately allocating the resources of the storage system. Problems, configurations, and effects other than those described above will be clarified by the following description of embodiment.

### BRIEF DESCRIPTION OF THE DRAWINGS

FIG. 1 is an explanatory diagram of a storage system of a first embodiment;

FIG. 2 is an explanatory diagram of a physical configuration of the storage system;

FIG. 3 is an explanatory diagram of a redundant configuration of a storage control program and a memory;

FIG. 4 is an explanatory diagram of data redundancy in a non-compression volume;

FIG. 5 is an explanatory diagram of data redundancy in a compression volume;

FIG. 6 is a diagram illustrating an example of a program and a table stored in a memory;

FIG. 7 is a specific example of an address conversion table;

FIG. 8 is a specific example of a compressed data address conversion table;

FIG. 9 is a specific example of a volume configuration management table;

FIG. 10 is a specific example of a core allocation ratio management table;

FIG. 11 is a specific example of a core management table;

FIG. 12 is a specific example of a core allocation adjustment target program per core number management table;

FIG. 13 is a flowchart of write processing for a non-compression volume;

FIG. 14 is a flowchart of processing of destaging non-compressed user data;

FIG. 15 is a flowchart of compressed data write processing;

FIG. 16 is a flowchart of processing of destaging compressed data;

FIG. 17 is a flowchart of core number adjustment of the first embodiment;

FIG. 18 is a flowchart illustrating details of a core number increase/decrease processing;

FIG. 19 is a volume configuration management table in a system of a second embodiment;

FIG. 20 is an explanatory diagram of a per-attribute I/O processing overhead management table included in the system of the second embodiment;

FIG. 21 is a flowchart of core number adjustment of the second embodiment;

FIG. 22 is a flowchart illustrating details of core allocation ratio calculation processing;

FIG. 23 is an explanatory diagram of failover;

FIG. 24 is an explanatory diagram of a cluster management table used in a third embodiment;

FIG. 25 is a flowchart illustrating a failover processing procedure;

FIG. 26 is a flowchart of core number adjustment according to the third embodiment; and

FIG. 27 is a flowchart of core number adjustment for a plurality of storage control programs.

### DESCRIPTION OF THE PREFERRED EMBODIMENTS

In the following description, an “interface device” may be one or more communication interface devices. The one or more communication interface devices may be one or more communication interface devices of the same type (for example, one or more network interface cards (NIC)) or two or more communication interface devices of different types (for example, an NIC and a host bus adapter (HBA)).

Further, in the following description, a “memory” may be one or more memory devices which are an example of one or more storage devices, and may typically be a main storage device. At least one memory device in the memory may be a volatile memory device or a non-volatile memory device.

Further, in the following description, a “persistent storage apparatus” may be one or more persistent storage devices which are an example of one or more storage devices. The persistent storage device may typically be a non-volatile storage device (for example, an auxiliary storage device), and specifically, for example, may be a hard disk drive (HDD), a solid state drive (SSD), a non-volatile memory express (NVMe) drive, or a storage class memory (SCM).

Further, in the following description, a “storage apparatus” may be at least a memory of the memory and a persistent storage apparatus.

Further, in the following description, a “processor” may be one or more processor devices. At least one processor device may typically be a microprocessor device such as a central processing unit (CPU), but may be another type of processor device such as a graphics processing unit (GPU). The at least one processor device may be a single core or a multi-core. The at least one processor device may be a processor core. The at least one processor device may be a processor device in a broad sense such as a hardware circuit (for example, a field-programmable gate array (FPGA) or an application specific integrated circuit (ASIC)) that performs a part or all of processing.

In addition, in the following description, information for obtaining an output with respect to an input will be described with an expression such as “xxx table”. However, the information may be data having any structure (for example, it may be structured data or unstructured data), or may be a learning model such as a neural network that generates an output with respect to an input. Therefore, the “xxx table” can be referred to as “xxx information”. Further, in the following description, the configuration of each table is an example, and one table may be divided into two or more tables, or all or a part of two or more tables may be one table.

Furthermore, in the following description, there is a case where processing is described with a “program” as a subject, but the subject of the processing may be a processor (alternatively, a device such as a controller having the processor) since the program is executed by the processor to perform defined processing appropriately using a storage apparatus and/or an interface device. The program may be installed in a device such as a computer from a program source. The program source may be, for example, a program distribution server or a computer-readable (for example, non-transitory) recording medium. Further, in the following description, two or more programs may be implemented as one program, or one program may be implemented as two or more programs.

In addition, in the following description, a “storage system” includes a node group (for example, a distributed system) having a multi-node configuration including a plurality of storage nodes each having a storage apparatus. Each storage node may include one or more redundant array of independent (or inexpensive) disks (RAID) groups, but typically may be a general-purpose computer. Each of the one or more computers may execute predetermined software to construct the one or more computers as software-defined anything (SDx). As the SDx, for example, software defined storage (SDS) or software-defined datacenter (SDDC) can be adopted. For example, a storage system as SDS may be constructed by executing software having a storage function in each of one or more general-purpose computers. In addition, one storage node may execute a virtual computer as a host computer and a virtual computer as a storage control apparatus (typically, an apparatus that inputs/outputs data to/from a storage device unit in response to an I/O request) of a storage system. Further, it may be an on-premises, a cloud, or a hybrid thereof.

Further, in the following description, the “volume” may be referred to as “VOL”. “VOL” is an abbreviation for logical volume, and may be a logical storage device. VOL may be a substantial VOL (RVOL) or a virtual VOL (VVOL). “RVOL” may be VOL based on a physical storage resource (for example, one or more RAID groups) of the storage system that provides the RVOL. “VVOL” may be, for example, a capacity expansion VOL (TPVOL). TPVOL may be VOL including a plurality of virtual areas (virtual storage areas) and conforming to a capacity virtualization technology (typically, thin provisioning). “Pool” may be a storage area including a plurality of real areas (substantial storage areas) based on one or more persistent storage devices (for example, a persistent storage device in a storage node that manages the pool or a persistent storage device in a storage node that can communicate with the storage node). When the real area is not allocated to the virtual area (virtual area of TPVOL) to which the address specified by the received write request belongs, the storage system may allocate the real area from the pool to the virtual area (write destination virtual area) (even when another real area is allocated to the write destination virtual area, the real area may be newly allocated to the write destination virtual area). The storage system may write the write target data accompanying the write request to the allocated real area.

Further, in the following description, a common code among reference codes may be used when the similar elements are not distinguished and described, and a reference code may be used when the similar elements are distinguished and described. For example, the storage nodes may be described as a “storage node 150” when not particularly distinguished and described, and may be described as a “storage node 150A1” and a “storage node 150B1” when individual storage nodes are distinguished and described.

In addition, in the following description, an “I/O amount” of the storage node may be an amount of I/O caused by reception of one or more I/O commands by the storage node. As the “I/O amount”, at least one of an “I/O number” and an “I/O size” may be adopted. The “I/O number” may be the number of I/O commands received by the storage node or the number of I/O commands issued based on one or more received I/O commands. The destination of the issued I/O command may be a storage device in the storage node, or may be another storage node. The “I/O size” may be a total size of data which is input/output as the storage node receives one or more I/O commands. The “I/O amount” may be an amount according to a write amount, a read amount, or both a write amount and a read amount (for example, the sum of the write amount and the read amount). The description of the “write amount” may be a description in which “I/O” in the description of the “I/O amount” in this paragraph is replaced with “write”. Similarly, the description of the “read amount” may be a description in which the “I/O” in the description of the “I/O amount” in this paragraph is replaced with the “read”.

Further, in the following description, a “cluster” is two or more storage nodes. Data to be written generated in a certain cluster is made redundant (for example, duplicated) and stored in two or more storage nodes in the cluster. The cluster may include a storage control program 80 which is active and a storage control program 80 which is (failover) standby that takes over and starts processing of the storage control program 80 which is active when the storage control program 80 which is active is stopped. A combination of the storage control program 80 which is active and the storage control program 80 which is standby is determined in advance and arranged in different storage nodes. In addition, a plurality of storage control programs 80 belonging to different combinations can be operated on the same processor.

Hereinafter, an embodiment will be described in detail.

### First Embodiment

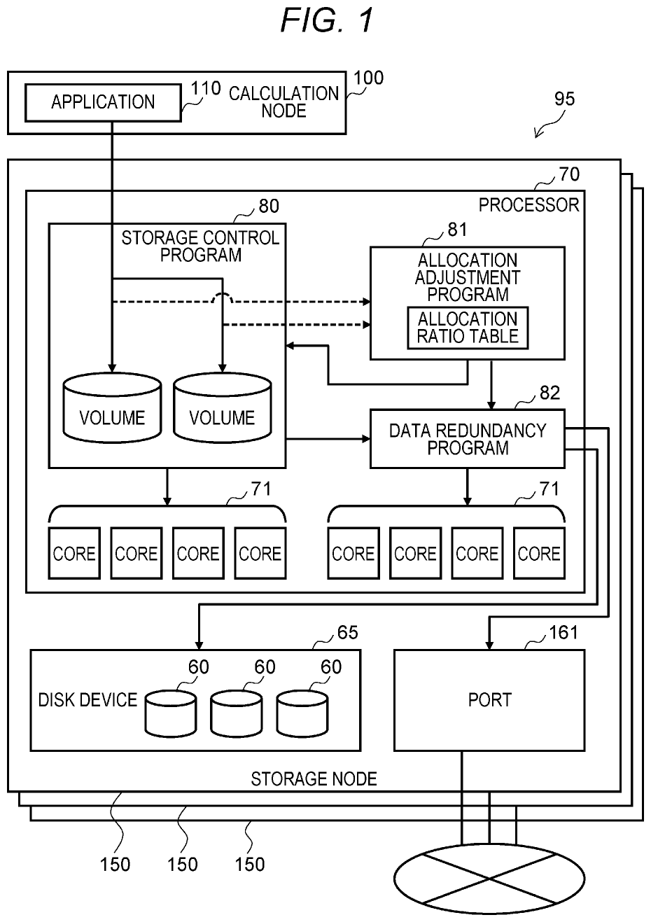

FIG. 1 is an explanatory diagram of a storage system of a first embodiment.

A storage system 95 of the first embodiment is a node group including a plurality of storage nodes 150. A storage node 150 is, for example, a computer (for example, a general-purpose computer) that executes predetermined software (for example, SDS software). The storage system 95 is communicably connected to a calculation node 100.

The calculation node 100 is a computer that executes an application 110 (application program). The calculation node 100 may be a physical computer or a virtual computer (for example, an execution environment such as a virtual machine or a container).

In the example of FIG. 1, the calculation node 100 and the storage node 150 are different nodes, but one node may also serve as two or more nodes among the nodes. For example, the calculation node 100 may be included in at least one storage node 150.

Each storage node 150 has a resource group which is a plurality of calculation resources such as an interface device, a storage apparatus, and a processor 70 connected thereto.

As an example of at least a part of the interface device, there is a port 161. The port 161 is an example of a communications interface device.

As an example of at least a part of the storage apparatus, there is a disk group 65 which is one or more disks 60. The disk 60 is an example of a storage device (in particular, a persistent storage device).

An example of at least a part of the processor 70 may be one or more CPUs, and the one or more CPUs have a plurality of processor cores (hereinafter, cores) 71. Both the CPU and the core 71 are examples of a processor device.

The processor 70 executes programs such as a storage control program 80, an allocation adjustment program 81, and a data redundancy program 82 using the plurality of cores 71.

The storage control program 80 configures a volume which is a logical storage area based on the physical storage area of the disk group 65. When the application 110 requests input/output of data to/from the volume, the storage control program 80 performs processing as input/output of data to/from the disk group 65. The data redundancy program 82 makes data input/output to/from the disk group 65 redundant.

The allocation adjustment program 81 adjusts the number of cores 71 to be allocated to the storage control program 80 and the data redundancy program 82 according to the attribute of the volume.

In FIG. 1, the allocation adjustment program 81 allocates four cores 71 to the storage control program 80 and allocates four cores 71 to the data redundancy program 82.

The allocation adjustment program 81 itself is also executed by any of the cores 71, but since the load is very small as compared with the storage control program 80 and the data redundancy program 82, allocation in units of cores is not required.

The attribute of the volume is, for example, whether the volume is a compression volume in which the function of compressing and storing data is enabled, or a non-compression volume (simplex volume) in which the function is disabled or absent and data is stored in a non-compressed manner. The compression and the expansion are performed by the storage control program 80.

In the plurality of volumes, a compression volume and a non-compression volume may be mixed. The allocation adjustment program 81 refers to an allocation ratio table in which the ratio of the compression volumes in the whole volumes is associated with the ratio of the cores 71 to be allocated to each program, and determines the number of cores 71 to be allocated to each program.

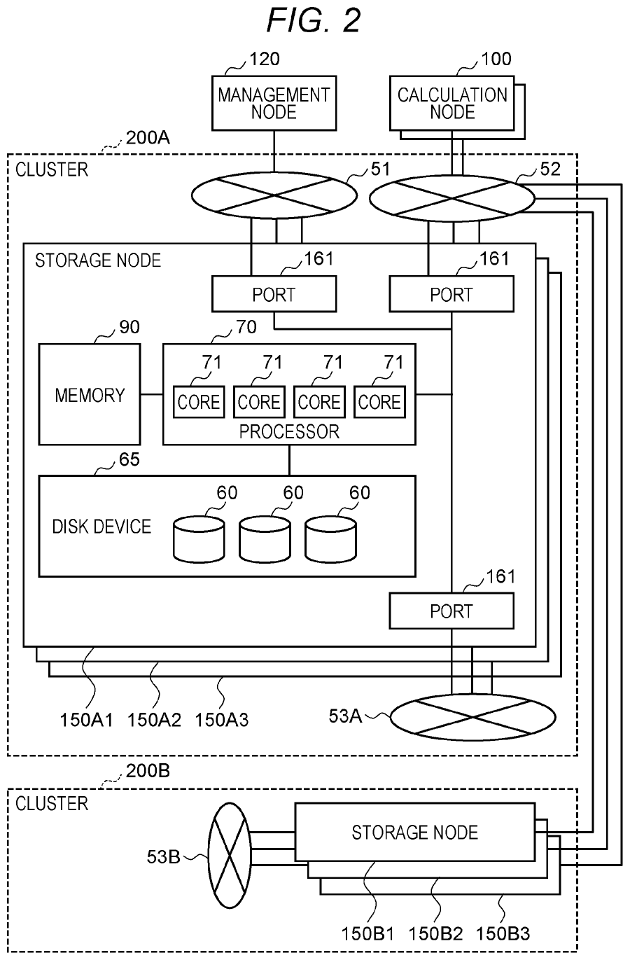

FIG. 2 is an explanatory diagram of a physical configuration of the storage system 95.

The storage system 95 includes a plurality of clusters 200. Each cluster 200 includes two or more storage nodes 150. For example, a cluster 200A includes storage nodes 150A1 to 150A3, and a cluster 200B includes storage nodes 150B1 to 150B3. Each storage node 150 includes a memory 90 in addition to the calculation resources described with reference to FIG. 1. The memory 90 is connected to the processor 70. In addition, each storage node 150 is connected to a management node 120 in addition to the calculation node 100 described with reference to FIG. 1.

The management node 120 is a computer that executes management software. The management node 120 may be a physical computer or a virtual computer. The management node 120 manages an overall configuration of the storage system 95, an individual configuration of each storage node 150, a state of each storage node 150, and the like.

In each cluster 200, each storage node 150 communicates with the management node 120, the calculation node 100, and another storage node 150 via a network. The network includes one or more networks, for example, a first network 51, a second network 52, and a third network 53. The first network 51 is a network used for communication between the storage node 150 and the management node 120. The second network 52 is a network used for communication between the storage node 150 and the calculation node 100 (and the storage node 150 in another cluster 200). The third network 53 is a so-called internal network used for communication between the storage nodes 150 in the same cluster 200. The third network 53 exists for each cluster 200. For example, there are a network 53A used for communication between the storage nodes 150A and a network 53B used for communication between the storage nodes 150B.

In the configuration illustrated in FIG. 2, for example, the second network 52 may be a wide area network (WAN) or a local area network (LAN), and each of the first network 51 and the third network 53 may be a LAN. At least one of the first network 51, the second network 52, and the third network 53 may be made redundant. For example, the first network 51 and the second network 52 may be a common network without being separated from each other. For any of the networks 51 to 53, the connection standard may be Ethernet (registered trademark), Infiniband (registered trademark), or wireless.

The storage node 150 receives an I/O command from the application 110 via the second network 52.

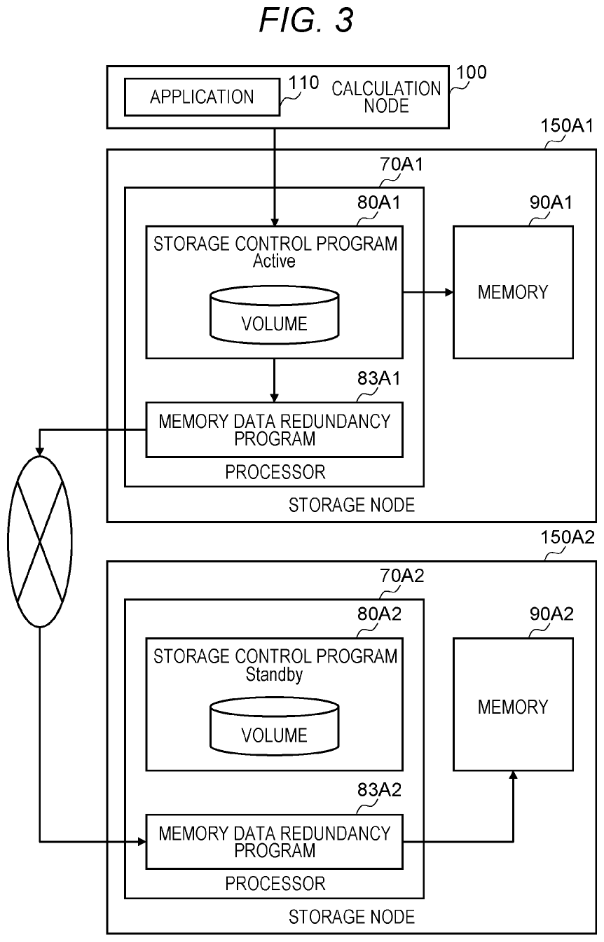

FIG. 3 is an explanatory diagram of a redundant configuration of the storage control program and the memory. In FIG. 3, in the storage control program, a storage control program 80A1 of the storage node 150A1 is active, and a storage control program 80A2 of the storage node 150A2 is standby.

A processor 70A1 of the storage node 150A1 executes a memory data redundancy program 83A1 in addition to the storage control program 80A1.

Similarly, a processor 70A2 of the storage node 150A2 executes a memory data redundancy program 83A2 in addition to the storage control program 80A2.

When the application 110 of the calculation node 100 issues an I/O command to the volume, the storage control program 80A1 which is active processes the I/O command. The storage control program 80A1 stores the result of the I/O in a memory 90A1.

The memory data redundancy program 83A1 sends the data stored in the memory 90A1 by the storage control program 80A1 to the memory data redundancy program 83A2. The memory data redundancy program 83A2 stores the data received from the memory data redundancy program 83A1 in a memory 90A2 of the storage node 150A2.

As a result, the data in the memory 90A1 and the data in the memory 90A2 can be matched with each other.

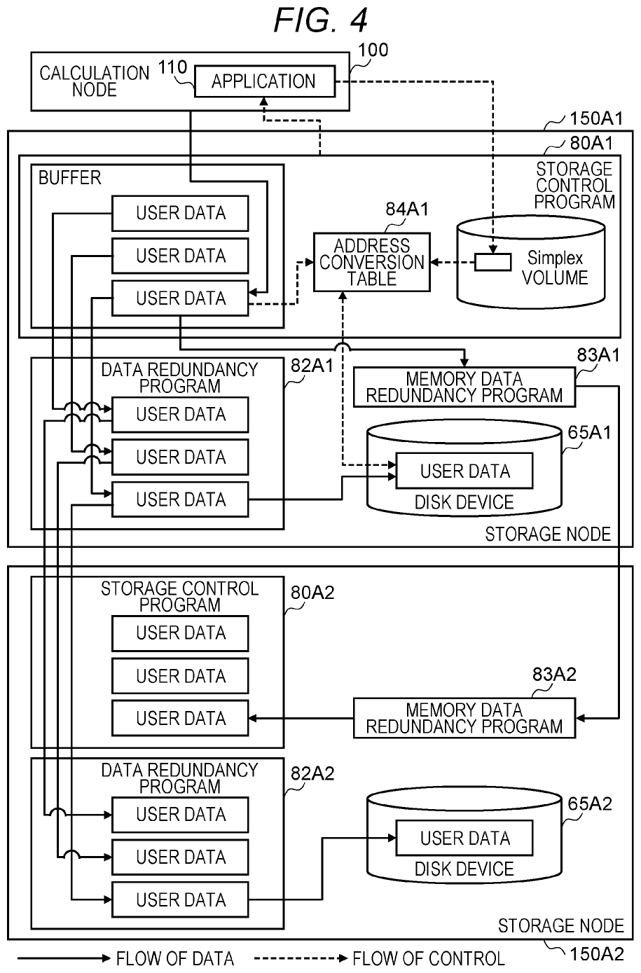

FIG. 4 is an explanatory diagram of data redundancy in a non-compression volume. In the present embodiment, duplexing is performed by the Mirror method, but an Ereasure Coding (EC) method using parity may be adopted. First, the application 110 of the calculation node 100 writes user data to the non-compression volume. The storage control program 80A1 of the storage node 150A1 stores write data in a buffer. As this buffer, a buffer area in the memory 90A1 is used. The address on the non-compression volume and the address in a disk group 65A1 are associated by an address conversion table 84A1.

In addition, the memory data redundancy program 83A1 of the storage node 150A1 reads the user data on the buffer and sends the user data to the memory data redundancy program 83A2 of the storage node 150A2. The memory data redundancy program 83A2 duplicates the user data received from the memory data redundancy program 83A1 by writing the user data in the buffer of the storage control program 80A2. Then, the user data is temporarily stored in disk groups 65A1 and 65A2 and non-volatilized, and then the storage control program 80A1 transmits a completion response to the application 110.

Thereafter, a data redundancy program 82A1 of the storage node 150A1 reads the user data on the buffer, performs processing of the storage function, writes the user data in the final storage area of the disk group 65A1, and sends the user data to a data redundancy program 82A2 of the storage node 150A2. The data redundancy program 82A2 writes the user data received from the data redundancy program 82A1 to the final storage area of the disk group 65A2.

As described above, according to the operation of FIG. 4, the user data written in the non-compression volume can be made redundant in both the buffer of the storage control program 80A and the disk group 65.

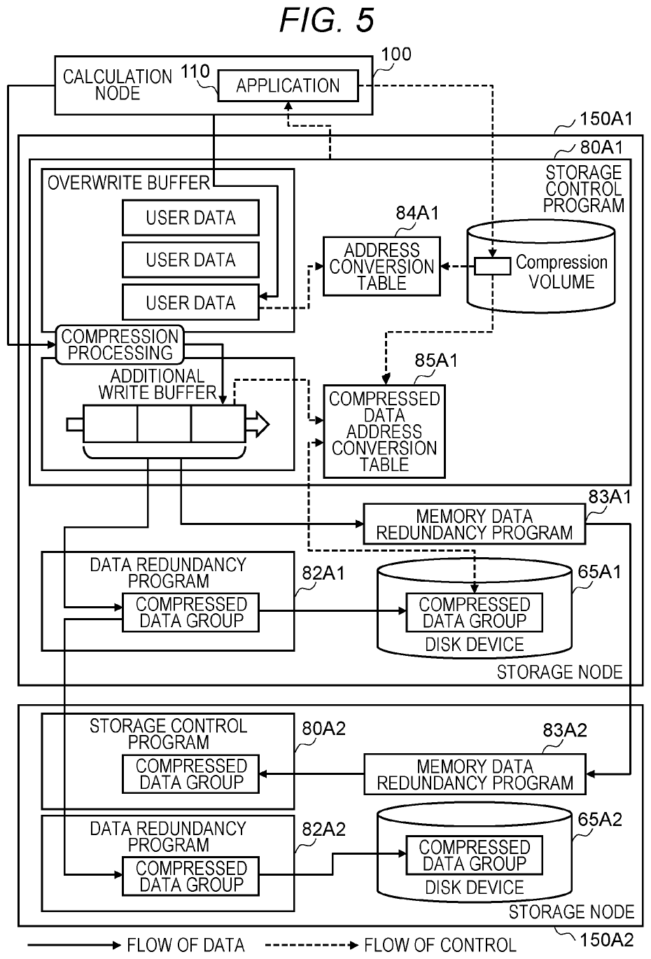

FIG. 5 is an explanatory diagram of data redundancy in the compression volume. First, the application 110 of the calculation node 100 writes user data to the compression volume. The storage control program 80A1 of the storage node 150A1 determines whether or not it is necessary to compress the user data. When the compression is not necessary, the storage control program 80A1 is stored in the overwrite buffer. The overwrite buffer corresponds to the buffer in FIG. 4. Processing subsequent to the case where compression is not necessary is similar to that in FIG. 4, and thus description thereof is omitted.

When compression is necessary, the storage control program 80A1 performs compression processing on the user data to generate compressed data, and stores the compressed data in the additional write buffer. The additional write buffer is an area provided in the memory 90A1 to temporarily store the compressed data. The address on the compression volume of the compressed data and the address in the disk group 65A1 are associated by a compressed data address conversion table 85A1.

In addition, the memory data redundancy program 83A1 of the storage node 150A1 reads the compressed data group on the additional write buffer and sends the compressed data group to the memory data redundancy program 83A2 of the storage node 150A2. The memory data redundancy program 83A2 duplicates the compressed data group received from the memory data redundancy program 83A1 by writing the compressed data group in the additional write buffer of the storage control program 80A2. Then, the user data is temporarily stored in disk groups 65A1 and 65A2 and non-volatilized, and then the storage control program 80A1 transmits a completion response to the application 110.

Thereafter, the data redundancy program 82A1 of the storage node 150A1 reads the compressed data group on the additional write buffer, performs processing of the storage function, writes the user data in the final storage area of the disk group 65A1, and sends the user data to the data redundancy program 82A2 of the storage node 150A2. The data redundancy program 82A2 writes the compressed data group received from the data redundancy program 82A1 to the final storage area of the disk group 65A2.

As described above, according to the operation of FIG. 5, the compressed data can be made redundant in both the buffer of the storage control program 80A and the disk group 65.

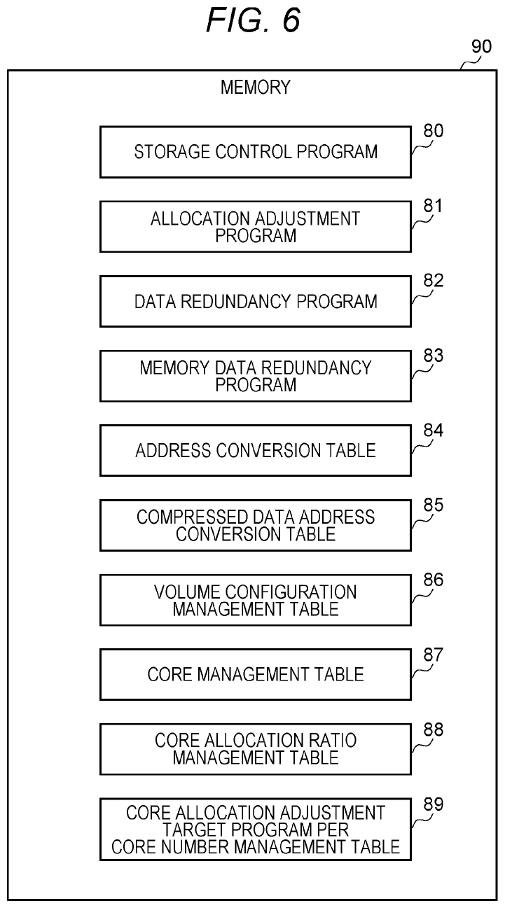

FIG. 6 is a diagram illustrating an example of a program and a table stored in the memory 90.

The memory 90 stores the storage control program 80, the allocation adjustment program 81, the data redundancy program 82, and a memory data redundancy program 83. In addition, the memory 90 stores an address conversion table 84, a compressed data address conversion table 85, a volume configuration management table 86, a core management table 87, a core allocation ratio management table 88, and a core allocation adjustment target program per core number management table 89. At least a part of these programs and tables may be stored in the disk 60.

The memory 90 illustrated in FIG. 6 may be the memory 90 of each storage node 150, may be the memory 90 of the storage node 150 of the master for each cluster 200, or may be any specific storage node 150. In addition, at least one table stored in the memory 90 illustrated in FIG. 6 may be stored in the management node 120.

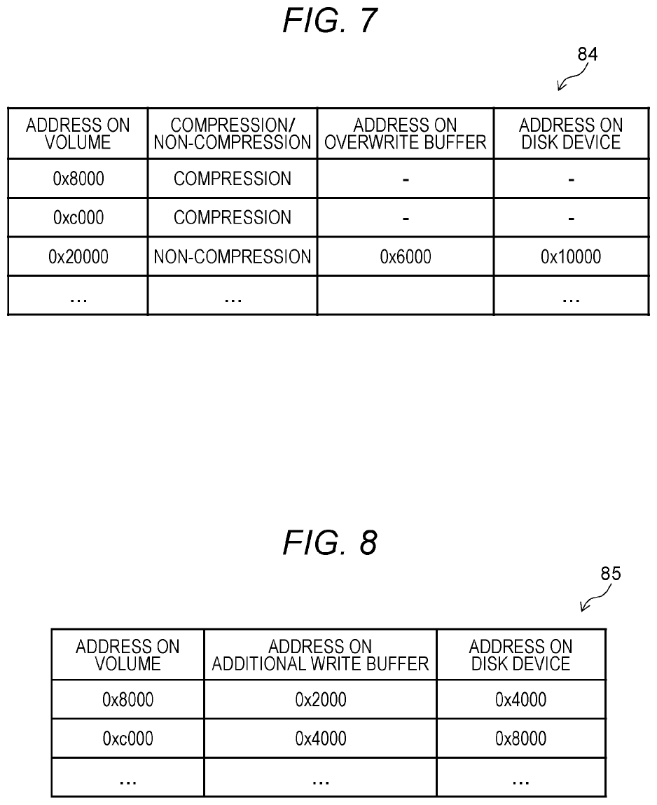

FIG. 7 is a specific example of the address conversion table 84. The address conversion table 84 associates an address on the volume, whether or not the address is used to store the compressed data, an address on the overwrite buffer, and an address on the disk device. In the addresses used to store the compressed data among the addresses on the volume, the address on the overwrite buffer and the address on the disk device are “no value”.

FIG. 8 is a specific example of the compressed data address conversion table 85. The compressed data address conversion table 85 associates an address on the volume, an address on the additional write buffer, and an address on the disk device.

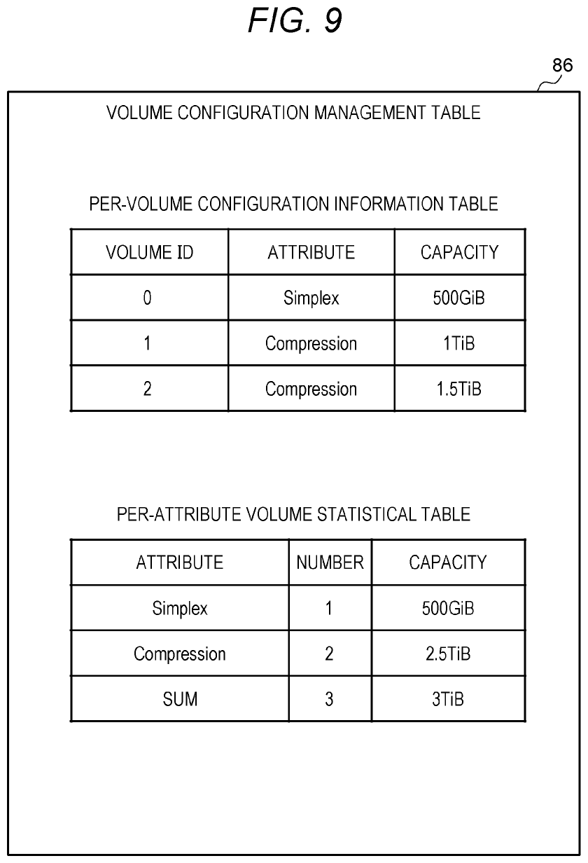

FIG. 9 is a specific example of the volume configuration management table 86. The volume configuration management table 86 includes a per-volume configuration information table and a per-attribute volume statistical table.

In the per-volume configuration information table, an attribute and a capacity are associated with a volume ID. The volume ID is identification information for uniquely specifying the volume. The attribute is “Simplex” in a case where the volume is a non-compression volume, and “Compression” in a case where the volume is a compression volume. In FIG. 9, the volume ID “0” has the attribute “Simplex” and the capacity “500 GiB”, the volume ID “1” has the attribute “Compression” and the capacity “1 TiB”, and the volume ID “2” has the attribute “Compression” and the capacity “1.5 TiB”.

The per-attribute volume statistical table indicates an attribute, the number of volumes having the attribute, and the sum of the capacities.

In FIG. 9, the attribute “Simplex” has the number of volumes of “1” and the sum of the capacities of “500 GiB”. In the attribute “Compression”, the number of volumes is “2”, and the sum of the capacities is “2.5 TiB”. Then, in the sum of all the attributes, the number of volumes is “3”, and the sum of the capacities is “3TiB”.

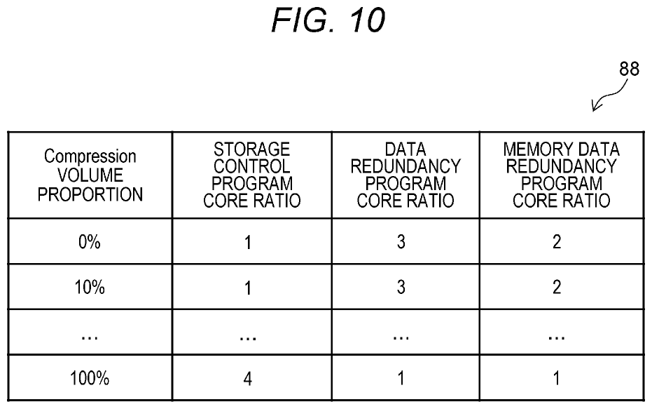

FIG. 10 is a specific example of the core allocation ratio management table 88. The core allocation ratio management table 88 corresponds to the allocation ratio table of FIG. 1. The core allocation ratio management table 88 associates a storage control program core ratio, a data redundancy program core ratio, and a memory data redundancy program core ratio with the proportion of “Compression”.

In FIG. 10, “Storage control program core ratio: Data redundancy program core ratio:Memory data redundancy program core ratio” is “1:3:2” when the proportion of the “Compression” volume is “0%”, “1:3:2” when the proportion is “10%”, and “4:1:1” when the ratio is “100%”.

As described above, the core allocation ratio management table 88 increases the number of cores 71 to be allocated to the storage control program 80 when the proportion of the compression volume is high. Therefore, the allocation of the cores 71 can be optimized in consideration of the fact that a high load is required for data compression.

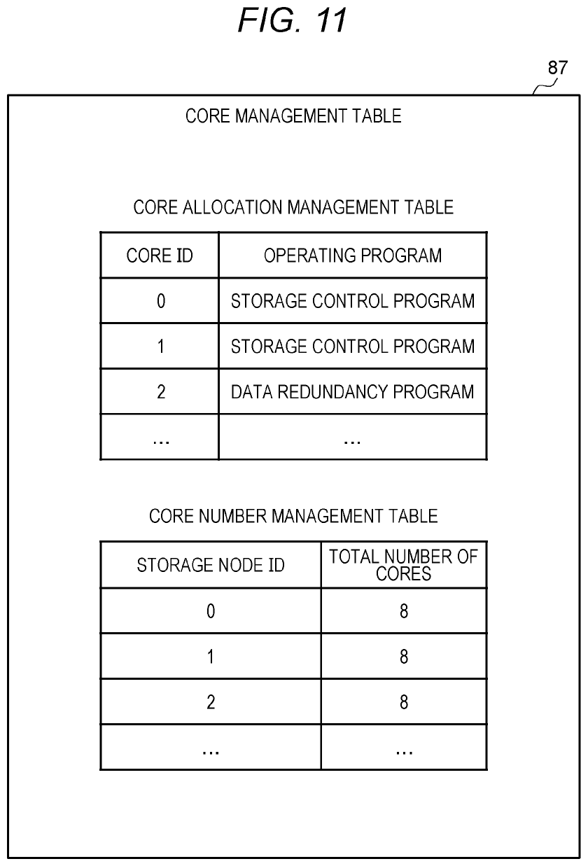

FIG. 11 is a specific example of the core management table 87. The core management table 87 includes a core allocation management table and a core number management table.

The core allocation management table is a table in which a program operating in the core is associated with a core ID for identifying the core 71.

The core number management table is a table in which the number of cores 71 operating in the storage node 150 is associated with the storage node ID for identifying the storage node 150.

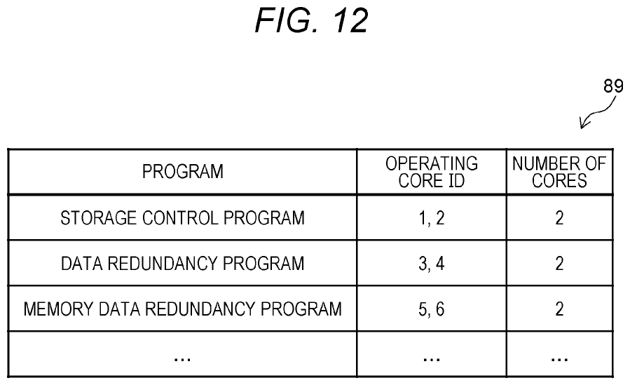

FIG. 12 is a specific example of the core allocation adjustment target program per core number management table 89. The core allocation adjustment target program per core number management table 89 associates the operating core ID and the number of cores with the program.

In FIG. 12, two cores 71 of a core ID “1” and a core ID “2” are allocated to the storage control program 80. Further, two cores 71 of a core ID “3” and a core ID “4” are allocated to the data redundancy program 82. Further, two cores 71 of a core ID “5” and a core ID “6” are allocated to the memory data redundancy program 83.

Next, an operation of the storage system will be described.

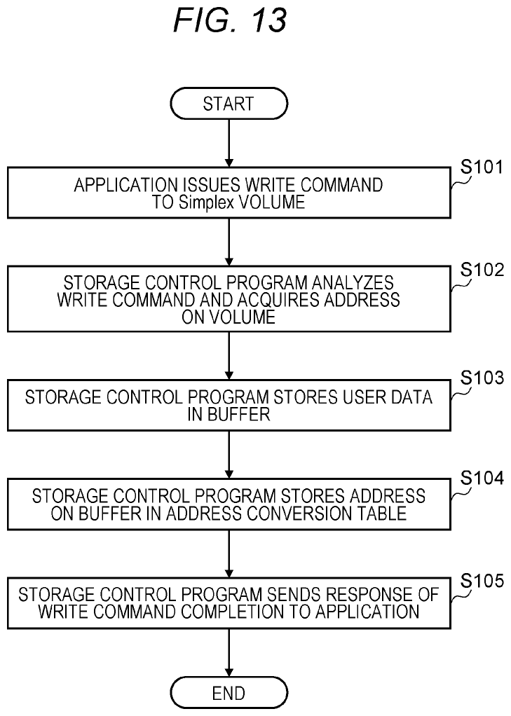

FIG. 13 is a flowchart of write processing for a non-compression volume.

First, the application 110 issues a write command to the non-compression volume (step S101). Subsequently, the storage control program 80 analyzes the write command and acquires an address for writing data on the volume (step S102). Subsequently, the storage control program 80 stores the user data in a buffer, and further temporarily stores and non-volatilizes the user data in a disk (step S103). Subsequently, the storage control program 80 stores the address on the buffer in the address conversion table 84 to correspond to the address on the volume (step S104). Subsequently, the storage control program 80 sends a response of write command completion to the application 110 (step S105), and ends the processing.

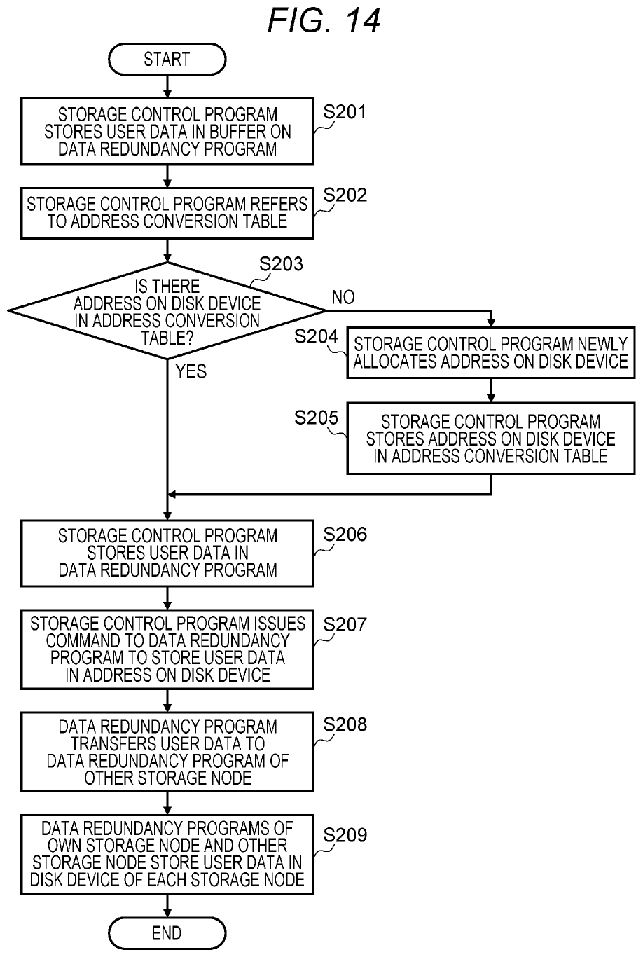

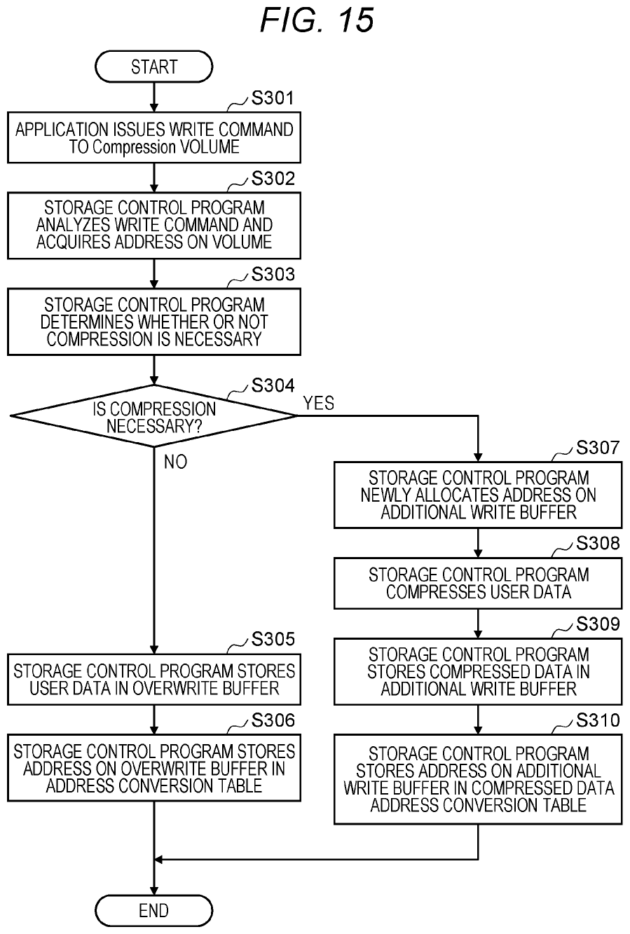

FIG. 14 is a flowchart of processing of destaging non-compressed user data.

First, the storage control program 80 stores the user data in a buffer on the data redundancy program (step S201). Subsequently, the storage control program 80 refers to the address conversion table 84 (step S202).

When there is no address on the disk device in the address conversion table 84 (step S203; No), the storage control program 80 newly allocates an address on the disk device (step S204). Subsequently, the storage control program 80 stores the address on the disk device in association with the address conversion table 84 (step S205).

After Step S205, or when there is an address on the disk device in the address conversion table 84 (Step S203; Yes), the storage control program 80 stores the user data in the data redundancy program 82 (step S206). Thereafter, the storage control program 80 issues a command to the data redundancy program 82 to store the user data in the address on the disk device (step S207).

The data redundancy program 82 transfers the user data to the data redundancy program 82 of the other storage node 150 (step S208). The data redundancy programs 82 of the own storage node 150 and the other storage node 150 store the user data in the disk device of each storage node 150 (step S209), and ends the processing.

FIG. 15 is a flowchart of compressed data write processing. First, the application 110 issues a write command to the compression volume (step S301). Subsequently, the storage control program 80 analyzes the write command and acquires an address on the volume (step S302). Subsequently, the storage control program 80 determines whether or not compression is necessary (step S303).

When compression is unnecessary (step S304; No), the storage control program 80 stores the user data in the overwrite buffer, further temporarily stores the user data in the disk, and non-volatilizes the user data (step S305). Subsequently, the storage control program 80 stores the address on the overwrite buffer in the address conversion table 84 (step S306), and ends the processing.

When compression is necessary (step S304; Yes), the storage control program 80 newly allocates an address on the additional write buffer (step S307). Thereafter, the storage control program 80 compresses the user data (step S308). Subsequently, the storage control program 80 stores the compressed data obtained by compressing the user data in the additional write buffer, further temporarily stores the compressed data in the disk, and non-volatilizes the user data (step S309). Thereafter, the storage control program 80 stores the address on the additional write buffer in the compressed data address conversion table 85 (step S310), and ends the processing.

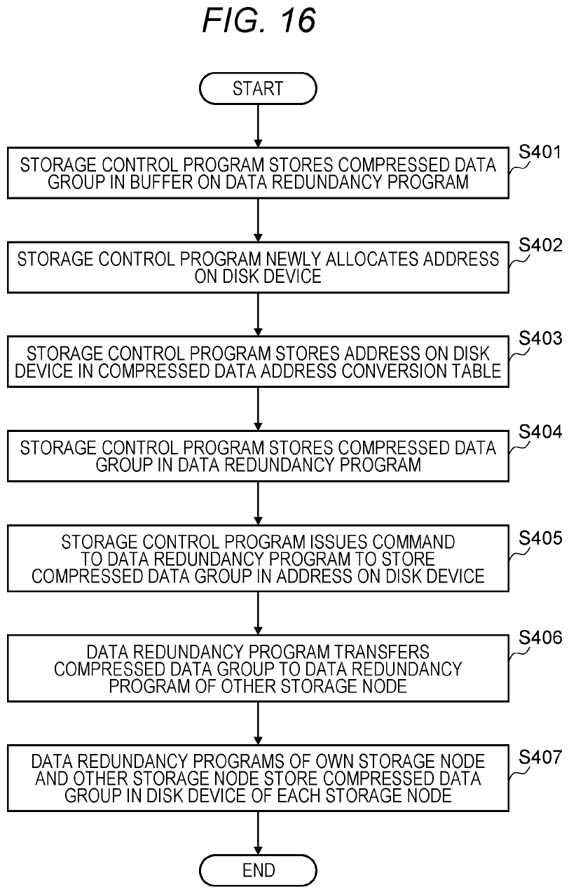

FIG. 16 is a flowchart of processing of destaging compressed data.

First, the storage control program 80 stores the compressed data group in the buffer on the data redundancy program (step S401). Subsequently, the storage control program 80 newly allocates an address on the disk device (step S402). Subsequently, the storage control program 80 stores the address on the disk device in the compressed data address conversion table 85 (step S403).

Thereafter, the storage control program 80 stores the compressed data group in the data redundancy program 82 (step S404). Subsequently, the storage control program 80 issues a command to the data redundancy program 82 to store the compressed data group in the address on the disk device (step S405).

The data redundancy program 82 transfers the compressed data group to the data redundancy program 82 of the other storage node 150 (step S406). The data redundancy programs 82 of the own storage node 150 and the other storage node 150 store the compressed data group in the disk device of each storage node 150 (step S407), and ends the processing.

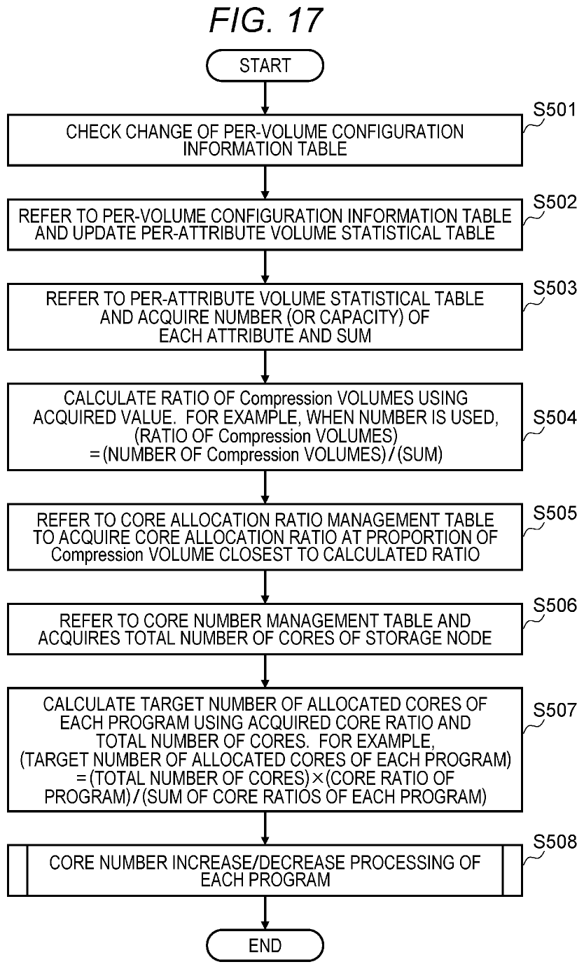

FIG. 17 is a flowchart of core number adjustment of the first embodiment.

First, the allocation adjustment program 81 checks the update of the per-volume configuration information table (step S501). The allocation adjustment program 81 refers to the per-volume configuration information table and updates the per-attribute volume statistical table (step S502). Thereafter, the allocation adjustment program 81 refers to the per-attribute volume statistical table and acquires the number of volumes of each attribute and the sum (step S503). Here, the number of volumes of each attribute is acquired, but may be implemented as a configuration for acquiring the capacity of the volume of each attribute.

After step S503, the allocation adjustment program 81 calculates the ratio of the compression volumes using the acquired value (step S504). For example, when the number of volumes is used, it can be obtained as (ratio of compression volumes)=(number of compression volumes)/(sum of the number of compression volumes and the number of non-compression volumes).

After step S504, the allocation adjustment program 81 refers to the core allocation ratio management table to acquire the core allocation ratio at the proportion of the compression volume closest to the calculated ratio (step S505). In addition, the allocation adjustment program 81 refers to the core number management table and acquires the total number of cores of the storage node (step S506).

Thereafter, the allocation adjustment program 81 calculates the target number of allocated cores of each program using the acquired core ratio and total number of cores (step S507). For example, it is obtained by (target number of allocated cores of each program)=(total number of cores)×(core ratio of the program)/(sum of core ratios of each program). The target number of allocated cores is desirably rounded to an integer.

After Step S507, the allocation adjustment program 81 performs core number increase/decrease processing of each program (Step S508), and ends the processing.

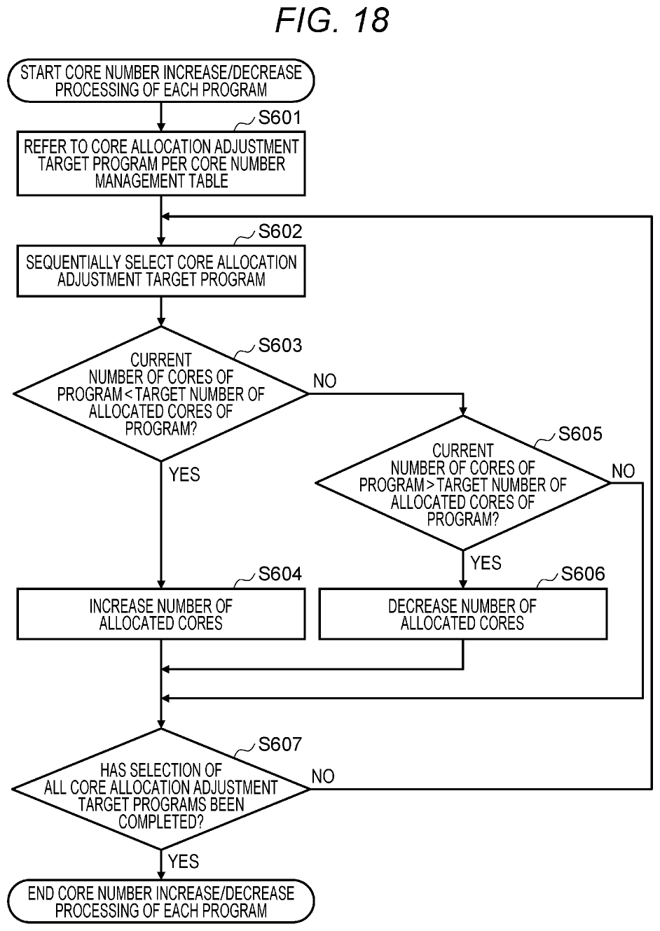

FIG. 18 is a flowchart illustrating details of the core number increase/decrease processing.

When the core number increase/decrease processing is started, the allocation adjustment program 81 refers to the core allocation adjustment target program per core number management table 89 (step S601). Then, the allocation adjustment program 81 sequentially selects the core allocation adjustment target program (step S602).

In the allocation adjustment program 81, for the program selected in step S602, when the current number of cores of the program is less than the target number of allocated cores of the program (step S603; Yes), the number of allocated cores for the program is increased (step S604).

In the allocation adjustment program 81, for the program selected in step S602, when the current number of cores of the program has reached the target number of allocated cores of the program (step S603; No), and when the current number of cores of the program exceeds the target number of allocated cores of the program (step S605; Yes), the number of allocated cores for the program is decreased (step S606).

After Step S604, after Step S606, or for the program selected in Step S602, when the current number of cores of the program is equal to the target number of allocated cores of the program (Step S605; No), the allocation adjustment program 81 determines whether the selection of all the core allocation adjustment target programs is completed (step S607). When there is an unselected core allocation adjustment target program (step S607; No), the process returns to step S602. When the selection of all the core allocation adjustment target programs has been completed (step S607; Yes), the allocation adjustment program 81 ends the core number increase/decrease processing.

### Second Embodiment

In the first embodiment, the case of determining the allocation of the cores 71 to the core allocation adjustment target programs (storage control program 80, data redundancy program 82, and memory data redundancy program 83) according to the ratio between the compression volumes and the non-compression volumes has been described.

In a second embodiment, a configuration in which the number of processor cores to be allocated to the core allocation adjustment target program is determined according to the number of inputs/outputs of data with respect to the volume will be described.

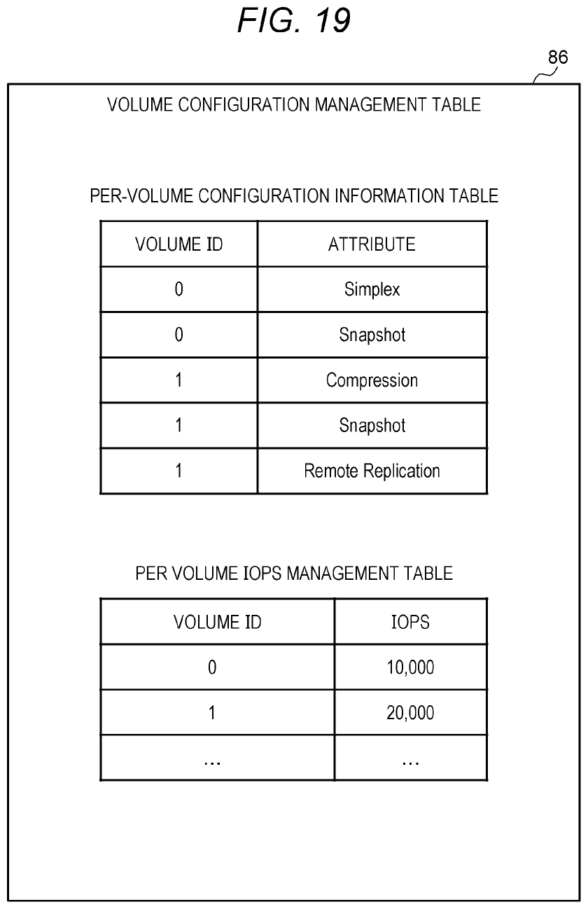

FIG. 19 is an explanatory diagram of a volume configuration management table in the system of the second embodiment.

In the storage system of the second embodiment, the volume configuration management table 86 includes a per-volume configuration information table and a per volume IOPS management table.

The per-volume configuration information table associates an attribute with a volume ID. The attributes include “Simplex”, “Compression”, “Snapshot”, “Remote Replication”, and the like. The volume having the attribute “Snapshot” is set so as to create a snapshot at a predetermined trigger. The volume having the attribute “Remote Replication” is set so as to create a copy in another node by remote replication. In FIG. 19, the volume having the volume ID “0” has the attribute “Simplex” and the attribute “Snapshot”. The volume having the volume ID “1” has the attribute “Compression”, the attribute “Snapshot”, and the attribute “Remote Replication”.

The per volume IOPS management table associates IOPS (the number of inputs/outputs per second) with the volume ID. In FIG. 19, the volume with the volume ID “0” is IOPS “10,000”. The volume with the volume ID “1” is IOPS “20,000”.

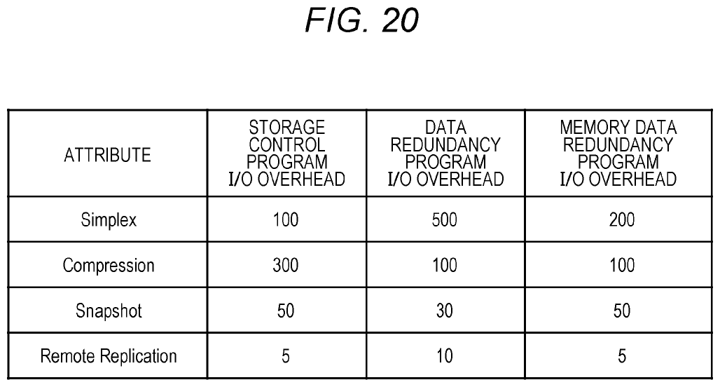

FIG. 20 is an explanatory diagram of a per-attribute I/O processing overhead management table included in the system of the second embodiment.

The per-attribute I/O processing overhead management table indicates a correspondence between the attribute and the overhead of the core allocation adjustment target program.

In FIG. 20, in the storage control program 80, the overhead corresponding to the attribute “Simplex” is set to “100”, the overhead corresponding to the attribute “Compression” is set to “300”, the overhead corresponding to the attribute “Snapshot” is set to “50”, and the overhead corresponding to the attribute “Remote Replication” is set to “5”.

Further, in the data redundancy program 82, the overhead corresponding to the attribute “Simplex” is set to “500”, the overhead corresponding to the attribute “Compression” is set to “100”, the overhead corresponding to the attribute “Snapshot” is set to “30”, and the overhead corresponding to the attribute “Remote Replication” is set to “10”.

Further, in the memory data redundancy program 83, the overhead corresponding to the attribute “Simplex” is set to “200”, the overhead corresponding to the attribute “Compression” is set to “100”, the overhead corresponding to the attribute “Snapshot” is set to “50”, and the overhead corresponding to the attribute “Remote Replication” is set to “5”.

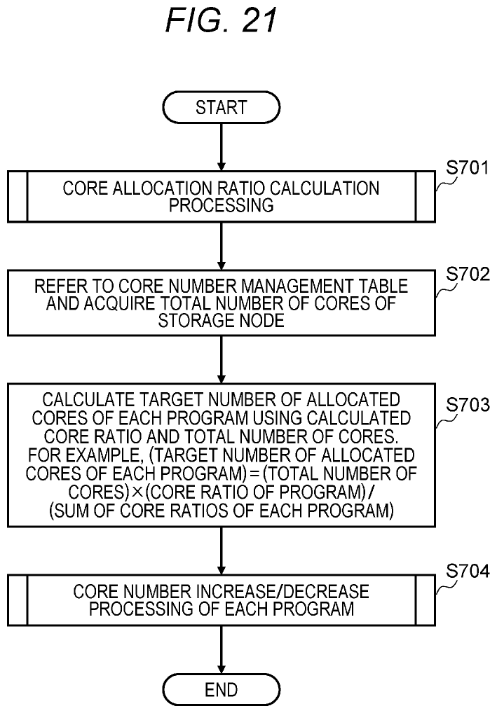

FIG. 21 is a flowchart of core number adjustment according to the second embodiment. When core number adjustment is started in the second embodiment, the allocation adjustment program 81 first executes core allocation ratio calculation processing (step S701). Details of the core allocation ratio calculation processing will be described later.

After the core allocation ratio calculation processing, the allocation adjustment program 81 refers to the core number management table and acquires the total number of cores of the storage node (step S702).

The allocation adjustment program 81 calculates the target number of allocated cores of each program using the calculated core ratio and total number of cores (step S703). For example, it may be obtained by (target number of allocated cores of each program)=(total number of cores)×(core ratio of the program)/(sum of core ratios of each program).

After Step S703, the allocation adjustment program 81 performs core number increase/decrease processing of each program (Step S704), and ends the processing. Since the core number increase/decrease processing of each program is similar to that of the first embodiment, the description thereof will be omitted.

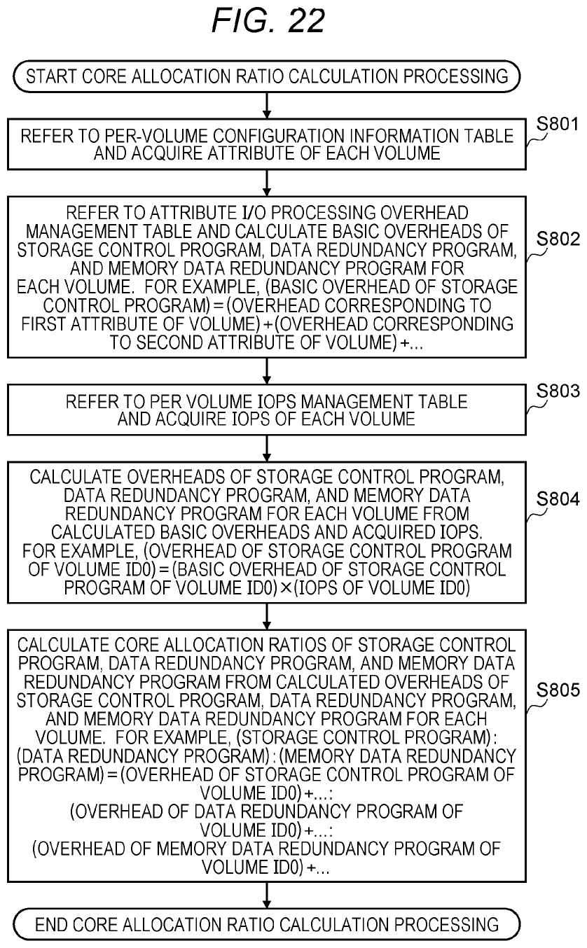

FIG. 22 is a flowchart illustrating details of the core allocation ratio calculation processing.

When starting the core allocation ratio calculation processing, the allocation adjustment program 81 refers to the per-volume configuration information table and acquires the attribute of each volume (step S801).

After step S801, the allocation adjustment program 81 refers to the attribute I/O processing overhead management table and calculates the basic overheads of the storage control program, the data redundancy program, and the memory data redundancy program for each volume (step S802).

The basic overhead may be obtained as follows, for example.

(basic overhead of storage control program)=overhead corresponding to first attribute of volume)+overhead corresponding to second attribute of volume)+ . . .

After Step S802, the allocation adjustment program 81 refers to the per volume IOPS management table and acquires IOPS of each volume (Step S803).

Thereafter, the allocation adjustment program 81 calculates the overheads of the storage control program, the data redundancy program, and the memory data redundancy program for each volume from the calculated basic overheads and the acquired IOPS (step S804).

For example, it may be determined as follows.

(overhead of storage control program of volume ID0)=(basic overhead of storage control program of volume ID0)×(IOPS of volume ID0)

After step S804, the allocation adjustment program 81 calculates the core allocation ratios of the storage control program, the data redundancy program, and the memory data redundancy program from the calculated overheads of the storage control program, the data redundancy program, and the memory data redundancy program for each volume (step S805), and ends the core allocation ratio calculation processing.

For example, it may be determined as follows.

(storage control program):(data redundancy program):(memory data redundancy program)=(overhead of storage control program of volume ID0)+ . . . :(overhead of data redundancy program of volume ID0)+ . . . :(overhead of memory data redundancy program of volume ID0)+ . . .

### Third Embodiment

In the first embodiment and the second embodiment, the case of determining the allocation of the cores 71 to the core allocation adjustment target programs according to the attribute of the volume has been described.

In a third embodiment, a case where the allocation of the cores 71 is determined according to the operating state of the storage node 150 will be described.

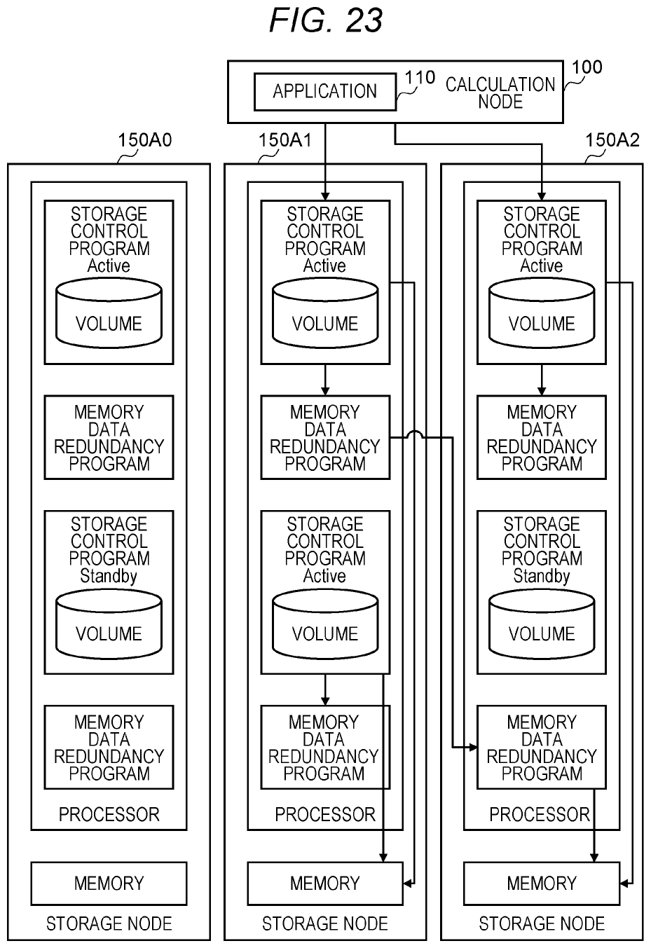

FIG. 23 is an explanatory diagram of failover. FIG. 23 illustrates a configuration in which the storage control program is made redundant in storage nodes 150A0 to 150A2. In addition, in FIG. 23, the storage node 150A0 is blocked due to a failure, and a failover occurs from a storage control program 80A0 of the storage node 150A0 to a storage control program 80A1 of the storage node 150A1. Therefore, in the storage node 150A1, the storage control program which is active and the control program which is standby operate before the failover, but after the failover, the storage control program which is originally active and the storage control program which becomes active from standby by the failover operate.

When the cores 71 used by other programs (the data redundancy program 82 and the memory data redundancy program 83) are allocated to the storage control program which becomes active by the failover, the overall performance deterioration width increases. Therefore, the allocation adjustment program 81 of the storage node 150A1 allocates the cores 71 to the storage control program which is originally active and the storage control program which becomes active by the failover while maintaining the allocation of the cores 71 to programs other than the storage control program.

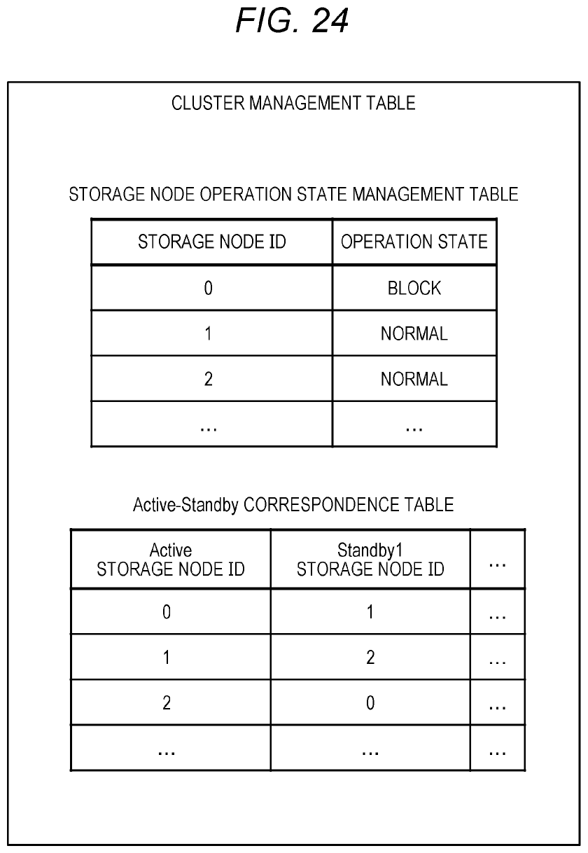

FIG. 24 is an explanatory diagram of a cluster management table used in the third embodiment. The cluster management table includes a storage node operation state management table and an Active-Standby correspondence table.

The storage node operation state management table associates an operation state with a storage node ID. The operation state indicates a state related to the operation of the storage node 150, such as “block” or “normal”.

The Active-Standby correspondence table indicates a redundant configuration of the storage node. In FIG. 24, the standby of the storage node ID “1” is associated with the active of the storage node ID “0”. In addition, the standby of the storage node ID “2” is associated with the active of the storage node ID “1”. In addition, the standby of the storage node ID “0” is associated with the active of the storage node ID “2”.

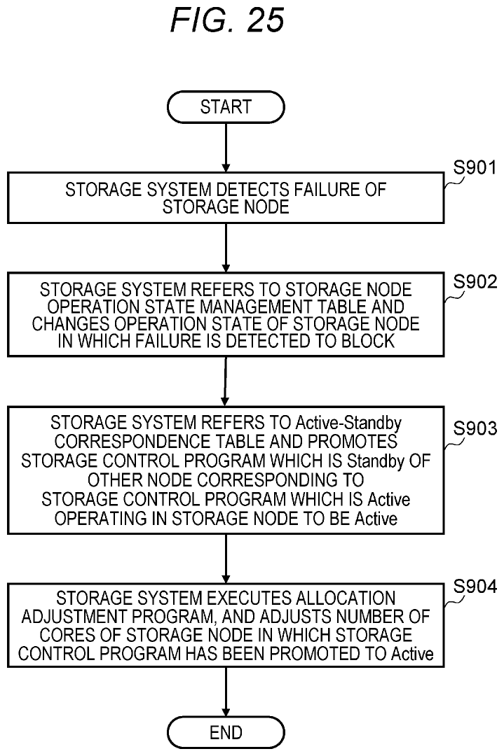

FIG. 25 is a flowchart illustrating a failover processing procedure.

First, the storage system 95 detects a failure of any of the storage nodes 150 (step S901). The storage system 95 refers to the storage node operation state management table and changes the operation state of the storage node in which the failure is detected to the block (step S902).

Thereafter, the storage system 95 refers to the Active-Standby correspondence table and promotes the storage control program 80 which is standby of another node corresponding to the storage control program 80 which is active operating in the storage node to active (step S903).

The storage system 95 executes the allocation adjustment program 81, adjusts the number of cores of the storage node 150 in which the storage control program 80 has been promoted to active (step S904), and ends the processing.

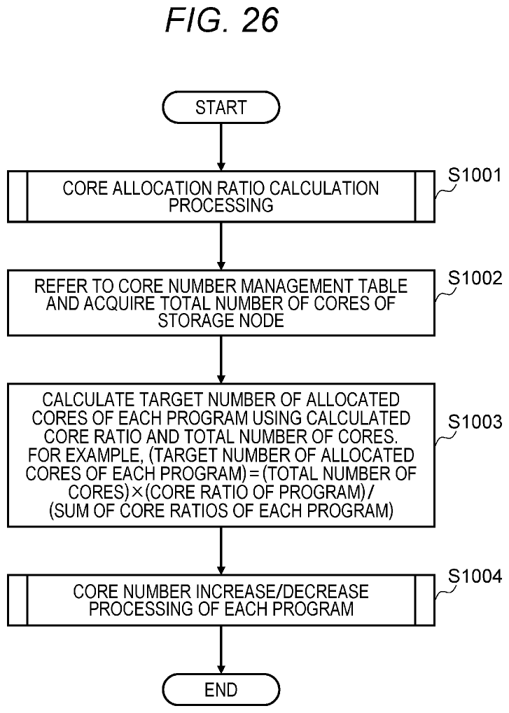

FIG. 26 is a flowchart of core number adjustment according to the third embodiment. When the core number adjustment is started in the third embodiment, the allocation adjustment program 81 first executes core allocation ratio calculation processing (step S1001).

After the core allocation ratio calculation processing, the allocation adjustment program 81 refers to the core number management table and acquires the total number of cores of the storage node (step S1002).

The allocation adjustment program 81 calculates the target number of allocated cores of each program using the calculated core ratio and total number of cores (step S1003). For example, it may be obtained by (target number of allocated cores of each program)=(total number of cores)×(core ratio of the program)/(sum of core ratios of each program).

After Step S1003, the allocation adjustment program 81 performs core number increase/decrease processing of each program (Step S1004), and ends the processing.

Here, the case where the core number adjustment similar to that of the second embodiment is performed has been described, but the core number adjustment similar to that of the first embodiment may be performed.

By the core number adjustment illustrated in FIG. 26, the allocation of the number of cores for each core allocation adjustment target program is determined. That is, how many cores 71 are allocated to the storage control program 80 is determined. In the third embodiment, the number of processor cores to be allocated to the storage control program 80 which is active (the storage control program 80 which is originally active) before the failover and the storage control program 80 (the storage control program 80 which is originally standby) shifted from standby to active by the failover is adjusted.

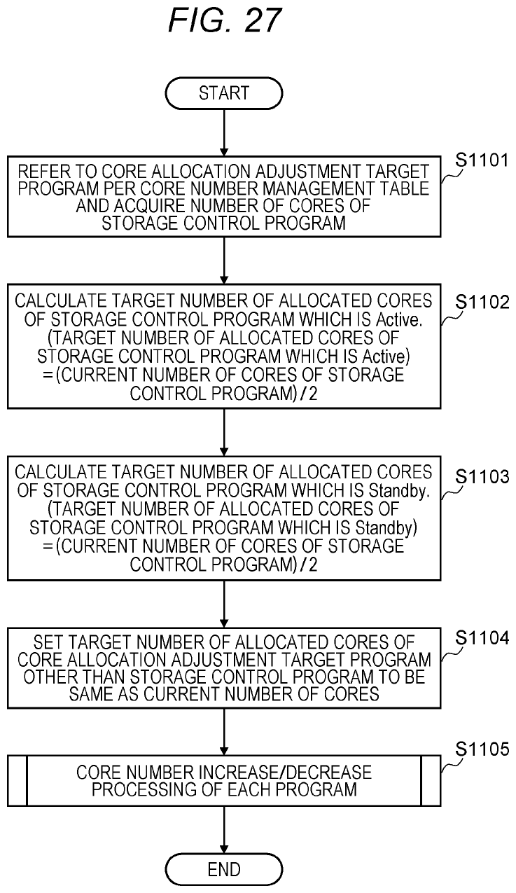

FIG. 27 is a flowchart of core number adjustment for a plurality of storage control programs.

First, the allocation adjustment program 81 refers to the core allocation adjustment target program per core number management table and acquires the number of cores of the storage control program (step S1101).

After Step S1101, the allocation adjustment program 81 calculates the target number of allocated cores of the storage control program 80 which is originally active (Step S1102). For example, it may be obtained as (target number of allocated cores of the storage control program which is originally active)=(current number of cores of the storage control program)/2.

After step S1102, the allocation adjustment program 81 calculates the target number of allocated cores of the storage control program 80 which is originally standby (step S1103). For example, it may be obtained as (target number of allocated cores of the storage control program which is originally standby)=(current number of cores of the storage control program)/2.

After step S1103, the allocation adjustment program 81 sets the target number of allocated cores of the core allocation adjustment target program other than the storage control program 80 to be the same as the current number of cores (step S1104).

After Step S1104, the allocation adjustment program 81 performs the core number increase/decrease processing of each program (Step S1105), and ends the processing.

As described above, the disclosed system is the storage system 95 including: the plurality of storage nodes 150 each including the processor 70; and the storage apparatus, in which the processor 70 includes the plurality of processor cores (cores 71), executes a plurality of programs for processing data input/output to/from the storage apparatus using the processor cores, provides a volume that is a logical storage area, and adjusts the number of processor cores to be allocated to each of the plurality of programs.

Therefore, it is possible to improve the performance of the storage system by appropriately allocating the resources of the storage system in consideration of the difference in load depending on the attribute of the volume and/or the operating state of the storage node.

In addition, the allocation of the processor cores to the program is changed on the basis of the attribute of the volume, and the attribute of the volume includes at least one of presence or absence of a function of compressing and storing the data and presence or absence of a function of generating a copy of the data.

Therefore, it is possible to allocate resources with high accuracy assuming a difference in load due to the presence or absence of data compression and a difference in load due to data copy.

Note that the function of generating a copy of the data can use a snapshot creation function or a remote copy function.

In addition, the program includes the storage control program 80 that provides the volume and compresses input/output data, the storage control program 80 provides the plurality of volumes including the compression volume that compresses the data and the non-compression volume that stores the data in a non-compressed manner, and the processor adjusts the number of processor cores to be allocated to the storage control program 80 based on the number of the compression volumes and the non-compression volumes.

Therefore, even when the compression volume and the non-compression volume are mixed, the performance of the storage system can be improved by appropriately allocating the sources.

In addition, the disclosed system determines the number of processor cores to be allocated to the storage control program 80 according to the attribute of the volume and the number of inputs/outputs of data with respect to the volume.

Therefore, the allocation of the processor cores can be dynamically changed in accordance with the variation in input/output.

In addition, in the disclosed system, for each of the plurality of volumes provided by the storage control program 80, the basic input/output overhead of each program is determined according to the attribute of the volume, the overhead in each program of each volume is calculated from the basic input/output overhead and the number of inputs/outputs of the data, the calculated overhead is added for each program, and the allocation of the processor cores is determined from the ratio of the added overhead for each program.

Therefore, it is possible to appropriately allocate the resources following the variation of the input/output in consideration of the attribute of the volume.

In addition, in the disclosed system, when the storage control program which is active and the storage control program which is standby are operating on the same processor of the storage node, and the storage control program which is standby is shifted to active by the failover, the number of processor cores to be allocated to the storage control program 80 which is active before the failover and the storage control program 80 that is shifted to active from standby by the failover is adjusted.

Therefore, resources can be allocated in accordance with the occurrence of failover, and performance deterioration can be suppressed.

In addition, the program includes the storage control program that provides the volume and compresses the input/output data, and the data redundancy program for making the data redundant and storing the data in the plurality of storage apparatuses. As the function of the attribute of the volume increases, a larger number of cores are set to be allocated to the storage control program, and a smaller number of cores are set to be allocated to the data redundancy program.

Therefore, resources can be allocated in accordance with the function of the attribute of the volume.

In addition, the program includes the data redundancy program for making the data redundant and storing the data in the plurality of storage apparatuses, and the number of processor cores to be allocated to the storage control program which is active before the failover and the storage control program shifted from standby to active by the failover is adjusted while maintaining a ratio of processor cores to be allocated to the storage control program 80 and the data redundancy program 82.

Therefore, it is possible to prevent the failover from compressing the operation of programs other than the storage control program 80, and to realize performance improvement.

Note that the present invention is not limited to the above embodiment, and includes various modifications. For example, the embodiment described above has been described in detail for easy understanding of the present invention, and is not necessarily limited to that having all the configurations described. In addition, the configuration can be replaced or added as well as the deletion of the configuration.

What is claimed is:

1. A storage system comprising:
a plurality of storage nodes each including a processor; and
a storage apparatus,
wherein the processor
includes a plurality of processor cores and executes a plurality of programs for processing data input/output to/from the storage apparatus by using the processor cores,
provides a volume that is a logical storage area, and
adjusts the number of processor cores to be allocated to each of the plurality of programs.

2. The storage system according to claim 1,
wherein the storage system changes an allocation of the processor cores to the program based on an attribute of a volume, and
wherein the attribute of the volume includes at least one of a function of compressing the data and a function of generating a copy of the data.

3. The storage system according to claim 2, wherein the function of generating a copy of the data is a snapshot creation function or a remote copy function.

4. The storage system according to claim 2,
wherein the program includes a storage control program that provides the volume and compresses input/output data,
wherein the storage control program provides a plurality of volumes including a compression volume that compresses and stores the data and a non-compression volume that stores the data in a non-compressed manner, and
wherein the processor adjusts the number of processor cores to be allocated to the storage control program based on the number of compression volumes and the number of non-compression volumes.

5. The storage system according to claim 4, wherein the number of processor cores to be allocated to the storage control program is determined according to the attribute of the volume and the number of inputs/outputs of data to and from the volume.

6. The storage system according to claim 5, wherein basic input/output overhead of each program is determined according to the attribute of the volume for each of the plurality of volumes provided by the storage control program, an overhead in each program of each volume is calculated from the basic input/output overhead and the number of inputs/outputs of the data, the calculated overhead is added for each program, and allocation of the processor cores is determined from a ratio of the added overhead for each program.

7. The storage system according to claim 4, wherein a storage control program which is active and a storage control program which is standby are operating on the same processor of the storage node, and when the storage control program which is standby is shifted to active by failover, the number of processor cores to be allocated to the storage control program which is active before the failover and the storage control program which is shifted to active from standby by the failover is adjusted.

8. The storage system according to claim 2,
wherein the program includes
a storage control program that provides the volume and compresses input/output data, and
a data redundancy program for making the data redundant and the data in a plurality of storage apparatuses, and
wherein, as a function of the attribute of the volume increases, a larger number of cores are set to be allocated to the storage control program, and a smaller number of cores are set to be allocated to the data redundancy program.

9. The storage system according to claim 8,
wherein the program includes a data redundancy program for making the data redundant and storing the data in the plurality of storage apparatuses, and
wherein, while maintaining a ratio of processor cores to be allocated to the storage control program and the data redundancy program, the number of processor cores to be allocated to a storage control program which is active before the failover and a storage control program shifted from standby to active by the failover is adjusted.

10. A management method for a storage system, the storage system including: a plurality of storage nodes each including a processor; and a storage apparatus,
wherein the processor
includes a plurality of processor cores and executes a plurality of programs for processing data input/output to/from the storage apparatus by using the processor cores;
provides a volume that is a logical storage area; and
adjusts the number of processor cores to be allocated to each of the plurality of programs.
